(19) United States
(12) Patent Application Publication
(10) Pub. No.: US 2005/0283014 A1
(43) Pub. Date: Dec. 22, 2005

(54) Bistropylidenediamines and use thereof

(76) Inventors: Hansjörg Grützmacher, (US); Pascal Maire, Liestal (CH)

Correspondence Address: LANXESS CORPORATION, 111 RIDC PARK WEST DRIVE, PITTSBURGH, PA, 15275-1112, US

(21) Appl. No.: 11/145,839

(22) Filed: Jun. 6, 2005

(30) Foreign Application Priority Data
Jun. 8, 2004 (DE) 1020040277729

(51) Int. Cl. C07F 15/00

(52) U.S. Cl. 556/137

(57) ABSTRACT

The present invention relates to bistropylidenediamines, to a process for their preparation and to the use thereof in catalysis.

### FIELD OF THE INVENTION

The present invention relates to bistropylidenediamines, to a process for their preparation and to the use thereof in catalysis.

### BACKGROUND OF THE INVENTION

Deblon (Thesis No. 13920, ETH Zurich, 2000, Chapter 5) and Maire (Thesis No. 14396, ETH Zurich, 2001) disclose that transition metal complexes of olefin-phosphine compounds are particularly suitable for homogeneous catalytic reactions, especially hydrogenations and hydrosilylations.

However, it would be advantageous for industrial applications to be able to dispense with the often expensive and oxidation-sensitive phosphines. There is therefore a need to provide a catalyst system and ligands suitable therefor, which does not need the use of phosphines and shows good performance in catalytic reactions.

### SUMMARY OF THE INVENTION

Compounds of the formula (I) have now been found 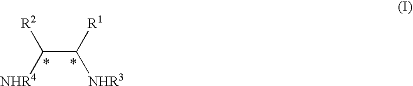
wherein

* marks a stereogenic carbon atom which may be (S)- or (R)-configured
R¹ and R² are each independently selected from the group of C₁-C₁₂-alkyl, C₁-C₁₂-alkoxy, C₁-C₁₂-haloalkoxy, C₁-C₁₂-haloalkyl, C₄-C₁₄-aryl, C₅-C₁₅-arylalkyl, or together are C₃-C₁₂-alkylene or C₃-C₁₂-alkenylene,
R³ and R⁴ are each independently radicals of the formula (II) 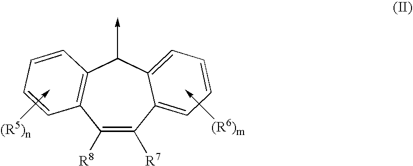
   where
the arrows each indicate the bond of the overall radical to the nitrogen atom or, when they point into the middle of an aromatic system, a bond of the particular radicals to the aromatic skeleton in any position,
R⁵ and R⁶ are each independently selected from the group of fluorine, chlorine, bromine, iodine, nitro, free or protected formyl, C₁-C₁₂-alkyl, C₁-C₁₂-alkoxy, C₁-C₁₂-haloalkoxy, C₁-C₁₂-haloalkyl, C₄-C₁₄-aryl, C₅-C₁₅-arylalkyl or radicals of the formula (IV)
   L-Q-T-W (IV)

wherein, each independently,
L is absent or is C₁-C₈-alkylene or C₂-C₈-alkenylene and
Q is absent or is oxygen, sulfur or NR⁹,
T is a carbonyl group and
W is R⁹, OR⁹, NHR⁹ or N(R¹⁰)₂,
   where N(R¹⁰)₂ as a whole may also be a 5- or 6-membered cyclic amino radical,
or radicals of the formulae (Va-g)
   L-W (Va)
   L-SO₂-W (Vb)
   L-NR¹²SO₂R¹² (Vc)
   L-SO₃Z (Vd)
   L-PO₃Z₂ (Ve)
   L-COZ (Vf)
   L-CN (Vg)

wherein L, Q, W and R¹⁰ are each as defined under formula (IV) and Z is hydrogen or M and
R⁷ and R⁸ are each independently hydrogen, cyano, fluorine, chlorine, bromine, iodine, C₁-C₁₈-alkyl, C₄-C₂₄-aryl, C₅-C₂₅-arylalkyl, CO₂M where M may be an alkali metal ion or an optionally organic ammonium ion, CONH₂, SO₂N(R⁹)₂ where R⁹ is hydrogen, C₁-C₁₂-alkyl, C₄-C₁₄-aryl or C₅-C₁₅-arylalkyl, SO₃M or are radicals of the formula (III),
   T-Het-R¹⁰ (III)
   wherein
   T is absent or is carbonyl,
   Het is oxygen or NR⁹,
   R¹⁰ is C₁-C₁₈-alkyl, C₄-C₂₄-aryl or C₅-C₂₅-arylalkyl or N(R¹⁰)₂ as a whole is a 5- or 6-membered cyclic amino radical and
n and m are each independently 0, 1, 2 or 3.

### DETAILED DESCRIPTION OF THE INVENTION

The compounds of the formula (I) are chiral. The invention encompasses all stereoisomers which occur as such, and any mixtures thereof. In the context of the invention, the terms stereoisomerically enriched (enantiomerically enriched or diastereomerically enriched) mean stereoisomerically pure (enantiomerically pure or diastereomerically pure) compounds or mixtures of stereoisomers (enantiomers or diastereomers) wherein one stereoisomer (enantiomer or diastereomer) is present in a larger proportion than another or the other. Stereoisomerically enriched means, for example and with preference, a content of one stereoisomer of 50% to 100% by weight, more preferably 70% to 100% by weight and most preferably 90 to 100% by weight, based on the sum of the particular stereoisomers.

The scope of the invention encompasses all combinations of radical definitions, parameters and illustrations above and listed below, in general or within areas of preference, with one another, i.e. also any combinations between the particular areas and areas of preference.

In the context of the invention, unless specifically stated otherwise, aryl is carbocyclic aromatic radicals, preferably phenyl, naphthyl, phenanthrenyl and anthracenyl, or heteroaromatic radicals wherein no, one, two or three skeleton carbon atoms per cycle, but at least one skeleton carbon atom in the entire molecule, is/are substituted by heteroatoms which are selected from the group of nitrogen, sulfur and oxygen, preferably pyridinyl, oxazolyl, thiophenyl, benzofuranyl, benzothiophenyl, dibenzofuranyl, dibenzothiophenyl, furanyl, indolyl, pyridazinyl, pyrazinyl, imidazolyl, pyrimidinyl and quinolinyl.

In addition, the carbocyclic, aromatic radicals or heteroaromatic radicals may be substituted by up to five identical or different substituents per cycle. For example and with preference, the substituents are selected from the group of bromine, fluorine, chlorine, nitro, cyano, free or protected formyl, free or protected hydroxyl, C₁-C₁₂-alkyl, C₁-C₁₂-haloalkyl, C₁-C₁₂-alkoxy, C₁-C₁₂-haloalkoxy, C₄-C₁₄-aryl, for example phenyl, C₅-C₁₅-arylalkyl, for example benzyl, di(C₁-C₁₂-alkyl)amino, (C₁-C₁₂-alkyl)amino, CO(C₁-C₁₂-alkyl), OCO(C₁-C₁₂-alkyl), NHCO(C₁-C₁₂-alkyl), N(C₁-C₈-alkyl)CO(C₁-C₁₂-alkyl), CO(C₄-C₁₄-aryl), OCO(C₄-C₁₄-aryl), NHCO(C₄-C₁₄-aryl), N(C₁-C₈-alkyl)CO(C₄-C₁₄-aryl), COO-(C₁-C₁₂-alkyl), COO-(C₄-C₁₄-aryl), CON(C₁-C₁₂-alkyl)₂ or CONH(C₁-C₁₂-alkyl)CO₂M, CONH₂, SO₂NH₂, SO₂N(C₁-C₁₂-alkyl)₂, SO₃M where M is in each case optionally substituted ammonium, lithium, sodium or potassium.

For example and with preference, aryl is phenyl or naphthyl which may be further substituted by no, one, two or three radicals per cycle which is/are selected from the group of fluorine, chlorine, cyano, C₁-C₈-alkyl, C₁-C₈-perfluoroalkyl, C₁-C₈-alkoxy, phenyl, benzyl, di(C₁-C₁₂-alkyl)amino, CO(C₁-C₁₂-alkyl), COO-(C₁-C₁₂-alkyl), CON(C₁-C₁₂-alkyl)₂ or SO₂N(C₁-C₁₂-alkyl)₂.

More preferably, aryl is phenyl which may be further substituted by no, one or two radicals per cycle which are selected from the group of fluorine, chlorine, cyano, C₁-C₄-alkyl, C₁-C₄-perfluoroalkyl, C₁-C₁₄-alkoxy, phenyl or SO₂N(C₁-C₄-alkyl)₂.

In the context of the invention, the definition and the areas of preference also apply analogously to aryloxy substituents and the aryl moiety of an arylalkyl radical.

In the context of the invention, unless specifically stated otherwise, protected formyl is a formyl radical which is protected by conversion to an aminal, acetal or a mixed aminal acetal, and the aminals, acetals and mixed aminal acetals may be acyclic or cyclic.

For example and with preference, protected formyl is a 1,1-(2,4-dioxycyclopentanediyl) radical.

In the context of the invention, unless specifically stated otherwise, protected hydroxyl is a hydroxyl radical which is protected by conversion to a ketal, acetal or a mixed aminal acetal, and the acetals and mixed aminal acetals may be acyclic or cyclic.

For example and with preference, protected hydroxyl is a tetrahydropyranyl radical (O-THP).

In the context of the invention, unless specifically stated otherwise, alkyl, alkylene, alkoxy, alkenyl and alkenylene are a straight-chain, cyclic, branched or unbranched alkyl, alkylene, alkoxy, alkenyl and alkenylene radical respectively, each of which may optionally be further substituted by C₁-C₄-alkoxy in such a way that each carbon atom of the alkyl, alkylene, alkoxy, alkenyl or alkenylene radical bears at most one heteroatom selected from the group of oxygen, nitrogen and sulfur.

The same applies to the alkylene moiety of an arylalkyl radical.

For example, in the context of the invention, C₁-C₄-alkyl is preferably methyl, ethyl, 2-ethoxyethyl, n-propyl, isopropyl, n-butyl, tert-butyl, C₁-C₈-alkyl is additionally, for example, n-pentyl, cyclohexyl, n-hexyl, n-heptyl, n-octyl or isooctyl, C₁-C₁₂-alkyl is further additionally, for example, norbornyl, adamantyl, n-decyl and n-dodecyl and C₁-C₁₈-alkyl is still further additionally n-hexadecyl and n-octadecyl.

For example, in the context of the invention, C₁-C₈-alkylene is preferably methylene, 1,1-ethylene, 1,2-ethylene, 1,1-propylene, 1,2-propylene, 1,3-propylene, 1,1-butylene, 1,2-butylene, 2,3-butylene and 1,4-butylene, 1,5-pentylene, 1,6-hexylene, 1,1-cyclohexylene, 1,4-cyclohexylene, 1,2-cyclohexylene and 1 ,8-octylene.

For example, in the context of the invention, C₁-C₄-alkoxy is preferably methoxy, ethoxy, isopropoxy, n-propoxy, n-butoxy and tert-butoxy, and C₁-C₈-alkoxy is additionally cyclohexyloxy.

For example, in the context of the invention, C₂-C₈-alkenyl is preferably ally, 3-propenyl and 4-butenyl.

For example, in the context of the invention, C₃-C₈-alkenylene is preferably 2-butenediyl.

In the context of the invention, unless specifically stated otherwise, haloalkyl and haloalkoxy are a straight-chain, cyclic, branched or unbranched alkyl and alkoxy radical respectively, each of which is substituted singly, multiply or fully by halogen atoms. Radicals which are fully substituted by fluorine are referred to as perfluoroalkyl and perfluoroalkoxy respectively.

For example, in the context of the invention, C₁-C₁₂-haloalkyl is trifluoromethyl, 2,2,2-trifluoroethyl, chloromethyl, fluoromethyl, bromomethyl, 2-bromoethyl, 2-chloroethyl, nonafluorobutyl, n-perfluorooctyl or n-perfluorododecyl.

The preferred substitution patterns for compounds of the formula (I) are defined below:
* preferably designates stereogenic carbon atoms each having identical configuration, i.e. (S),(S)- or (R),(R)-configuration.
R¹ and R² are preferably each independently selected from the group of C₁-C₁₂-alkyl, C₄-C₁₄-aryl, or together are C₃-C₁₂-alkylene, and are more preferably identically selected from the group of C₁-C₁₄-alkyl, phenyl, or together are 1,4-butylene.
R³ and R⁴ are preferably each independently radicals of the formula (II) wherein
   R⁵ and R⁶ are each independently hydrogen, fluorine, iodine, C₁-C₁₂-alkyl, C₁-C₁₂-alkoxy, C₄-C₁₀-aryl or radicals of the formula (IV) wherein T is in turn carbonyl and Het is oxygen or NR⁹, and
      wherein
   n and m are each independently 0 or 1 and wherein
   R⁷ and R⁸ are each independently selected from the group of fluorine, bromine, nitro, C₁-C₄-alkyl, C₁-C₄-alkoxy or radicals of the formulae (Vb) and (Vg),
R³ and R⁴ are more preferably a radical of the formula (II) wherein
   R⁵ and R⁶ are each independently hydrogen, C₁-C₁₂-alkyl, C₁-C₁₂-alkoxy, C₄-C₁₀-aryl
   n and m are each identically 0 or 1 and
   R⁷ and R⁸ are each identically selected from the group of fluorine and radicals of the formulae (Vb) and (Vg),
R³ and R⁴ are most preferably either a radical of the formula (II) wherein
   R⁵ and R⁶ are each independently hydrogen, C₁-C₁₂-alkyl, C₁-C₁₂-alkoxy or C₄-C₁₀-aryl and
   n and m are each 0.

Of compounds of the formula (I), very particular preference is given to those which bear radicals on the nitrogen atoms which are selected from the group of

10-cyano-5H-dibenzo[a,d]cyclohepten-5-yl (^{CN}trop), 5H-dibenzo[a,d]cyclohepten-5-yl (trop), 10-methyl-5H-dibenzo[a,d]cyclohepten-5-yl (^{Me}trop), 10-methoxy-5H-dibenzo[a,d]cyclohepten-5-yl (^{MeO}trop), 10-phenyl-5H-dibenzo[a,d]cyclohepten-5-yl (^{Ph}trop), 10,11-diphenyl-5H-dibenzo[a,d]cyclohepten-5-yl (^{Ph2}trop) [(5S)-10-[(-)-menthyloxy]-5H-dibenzo[a,d]cyclohepten-5-yl], (S-^{menthyloxy}trop) and [(5R)-10-[(-)-menthyloxy]-5H-dibenzo[a,d]cyclohepten-5-yl] (R-^{menthyloxy}trop).

To prepare compounds of the formula (I), compounds of the formula (VI) 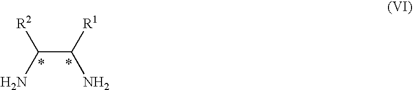
wherein R¹ and R² are each as defined above are preferably reacted, optionally in the presence of organic solvent, with compounds of the formula (VII) 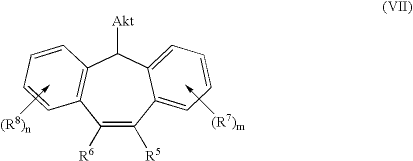
wherein R⁵, R⁶, R⁷, R⁸, n and m are each as defined above and wherein Akt is Chlorine, Bromine, Iodine, Trifluoracetyl or a sulfonyloxy radical the ammonium salts of the formulae (VIIIa) and/or (VIIIb) and/or (VIIIc) 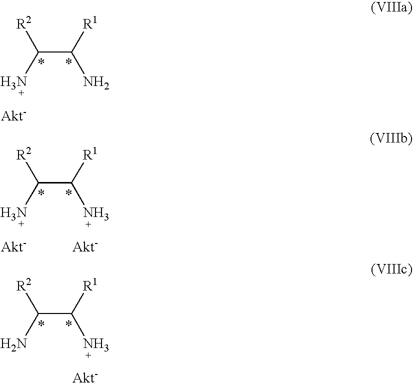
which are formed are preferably converted to compounds of the formula (I) in the presence of base, either in situ or in a subsequent reaction step.

The compounds of the formula (VII) are either known from the literature or can be synthesized analogously to the literature.

The reaction may optionally be, and is preferably, carried out in the presence of organic solvent.

Suitable organic solvents are, for example:

aliphatic or aromatic, optionally halogenated hydrocarbons, for example various benzines, benzene, toluene, xylene, chlorobenzene, dichlorobenzene, various petroleum ethers, hexane, cyclohexane, dichloromethane, chloroform, carbon tetrachloride; ethers such as diethyl ether, methyl tert-butyl ether, diisopropyl ether, dioxane, tetrahydrofuran or ethylene glycol dimethyl ether or ethylene glycol diethyl ether, or mixtures of such organic solvents. Preference is given to dichloromethane.

Suitable bases are, for example: alkaline earth metal or alkali metal hydrides, hydroxides, amides, alkyl-substituted disilylamides, dialkylamides, alkoxides or carbonates, for example sodium hydride, sodium amide, lithium diethylamide, sodium methoxide, sodium bistrimethylsilylamide, sodium ethoxide, potassium tert-butoxide, sodium hydroxide, potassium hydroxide, sodium carbonate and potassium carbonate, tertiary amines such as trimethylamine, triethylamine, tributylamine, trioctylamine, diisopropylethylamine, tetramethylguanidine, N,N-dimethylaniline, diazabicyclooctane (DABCO), diazabicyclononene (DBN) or diazabicycloundecene (DBU), piperidine and N-methylpiperidine. Preference is given to potassium carbonate.

Both the preparation process for the compounds of the formula (I) and the compounds of the formula (VIII) as indispensable intermediates are embraced fully by the invention.

The invention also includes transition metal complexes of compounds of the formula (I) and also catalysts which comprise the inventive transition metal complexes of compounds of the formula (I).

Preferred transition metal complexes are transition metal complexes of ruthenium, osmium, cobalt, rhodium, iridium, nickel, palladium, platinum and copper, preferably those of ruthenium, rhodium, iridium, nickel, palladium and platinum, more preferably those of rhodium and iridium.

The catalysts used may, for example, be isolated transition metal complexes which have been obtained, for example, from the compounds of the formula (I) and a metal compound, or transition metal complexes which are obtained from the compounds of the formula (I) and a metal compound in the reaction medium of the catalysis.

Suitable metal compounds are, for example and with preference, those of the formula (Ixa)
M¹(Y¹)ₚ (IXa)
wherein
M¹ is ruthenium, rhodium, iridium, nickel, palladium, platinum or copper and
Y¹is chloride, bromide, acetate, nitrate, methanesulfonate, trifluoromethanesulfonate or acetylacetonate and
p is 3 in the case of ruthenium, rhodium and iridium, is 2 in the case of nickel, palladium and platinum, and is 1 in the case of copper, or metal compounds of the general formula (IXb)
   M¹(Y²)ₚB¹₂ (IXb)
wherein
Y² is an anion, for example chloride, bromide, acetate, methanesulfonate, trifluoro-methanesulfonate, tetrafluoroborate, hexafluorophosphate, perchlorate, hexa-fluoroantimonate, tetra(bis-3,5-trifluoromethylphenyl)borate or tetraphenylborate and
p is 1 in the case of rhodium and iridium, is 2 in the case of nickel, palladium, platinum and ruthenium, and is 1 in the case of copper,
B¹ is in each case a C₂-C₁₂-alkene, for example ethylene or cyclooctene, or a nitrile, for example acetonitrile, benzonitrile or benzyl nitrile, or
B¹₂ together is a (C₄-C₂)-diene, for example norbornadiene or 1,5-cyclooctadiene or metal compounds of the formula (IXc)
   [M²B²Y¹₂]_{2 tm (IXc)}
wherein
M² is ruthenium and
B² is aryl radicals, for example cymene, mesityl, phenyl or cyclooctadiene, norbornadiene or methylallyl
   or metal compounds of the formula (IXd)
   Meₚ[M³(Y³)₄] (IXd)
where
M³ is palladium, nickel, iridium or rhodium and
Y³ is chloride or bromide and
Me is lithium, sodium, potassium, ammonium or organic ammonium and
p is 3 in the case of rhodium and iridium, or is 2 in the case of nickel, palladium and platinum
or metal compounds of the formula (IXe)
   [M⁴(B³)₂]An (IXe),
where
M⁴ is iridium or rhodium and
B³ is a (C₄-C₁₂)-diene, for example norbornadiene or 1,5-cyclooctadiene
An is a noncoordinating or weakly coordinating anion, for example methanesulfonate, trifluoromethanesulfonate, tetrafluoroborate, hexafluorophosphate, perchlorate, hexafluoroantimonate, tetra(bis-3,5-trifluoromethylphenyl)borate or tetraphenylborate.

Suitable metal compounds are additionally, for example, Ni(1,5-cyclooctadiene)₂, Pd₂(dibenzylideneacetone)₃, Pd[PPh₃]₄ cyclopentadienyl₂Ru, Rh(acac)(CO)₂, [RhCl(CO)₂]; Ir(pyridine)₂(1,5-cyclooctadiene), Ir(acac)(CO)₂, [IrCl(CO)₂], Cu(phenyl)Br, Cu(phenyl)Cl, Cu(phenyl)I, Cu(PPh₃)₂Br, [Cu(CH₃CN)₄]BF₄ and [Cu(CH₃CN)₄]PF₆ or polynuclear bridged complexes, for example [Rh(COD)Cl]₂ and [Rh(COD)Br]₂, [Rh(ethene)₂Cl]₂, [Rh(cyclooctene)₂Cl]₂.

The metal compounds used are preferably:

[Rh(COD)Cl]₂, [Rh(COD)₂Br], [Rh(COD)₂]ClO₄, [Rh(COD)₂]BF₄, [Rh(COD)₂]PF₆, [Rh(COD)₂]OTf, [Rh(COD)₂]BAr₄ (Ar =3,5-bistrifluoromethylphenyl) [Rh(COD)₂]SbF₆ RuCl₂(COD), [(cymene)RuCl₂]₂, [(benzene)RuCl₂]₂, [(mesitylene)RuCl₂]₂, [(cymene)RuBr₂]₂, [(cymene)RuI₂]₂, [(cymene)Ru(BF₄)₂]₂, [(cymene)Ru(PF₆)₂]₂, [(cymene)Ru(BAr₄)₂]₂, (Ar=3,5-bistrifluoromethylphenyl), [(cymene)Ru(SbF₆)₂]₂, [Ir(COD)₂Cl]₂, [Ir(COD)₂]PF₆, [Ir(COD)₂]ClO₄, [Ir(COD)₂]SbF₆ [Ir(COD)₂]BF₄, [Ir(COD)₂]OTf, [Ir(COD)₂]BAr₄ (Ar=3,5-bistrifluoromethylphenyl), RuCl₃, NiCl₂, RhCl₃, PdCl₂, PdBr₂, Pd(OAc)₂, Pd₂(dibenzylideneacetone)₃, Pd(acetylacetonate)₂, Rh(acetylacetonate)(CO)₂, [RhCl(CO)₂]; Ir(pyridine)₂(1,5-cyclooctadiene), Ir(acetylacetonate)(CO)₂, [IrCl(CO)₂] [Rh(nbd)Cl]₂, [Rh(nbd)₂Br], [Rh(nbd)₂]ClO₄, [Rh(nbd)₂]BF₄, [Rh(nbd)₂]PF₆, [Rh(nbd)₂]OTf, [Rh(nbd)₂]BAr₄ (Ar=3,5-bistrifluoromethylphenyl) [Rh(nbd)₂]SbF₆ RuCl₂(nbd), [Ir(nbd)₂]PF₆, [Rh(nbd)₂]ClO₄, [Rh(nbd)₂]BF₄, [Rh(nbd)₂]PF₆, [Rh(nbd)₂]OTf, (Ar=3,5-bistrifluoromethylphenyl), Ir(pyridine)₂(nbd), [Ru(DMSO)₄Cl₂], [Ru(CH₃CN)₄Cl₂], [Ru(PhCN)₄Cl₂], [Ru(COD)Cl₂]n, [Ru(COD)(methallyl)₂], [Ru(acetylacetonate)₃].

Even greater preference is given to Rh(acetylacetonate)(CO)₂, [RhCl(CO)₂] and Ir(acetylacetonate)(CO)₂, [IrCl(CO)₂], [Rh(nbd)₂]ClO₄, [Rh(nbd)₂]BF₄, [Rh(ndb)₂]PF₆, [Rh(nbd)₂]OTf, [Ir(nbd)₂]ClO₄, [Ir(nbd)₂]BF₄, [Ir(nbd)₂]PF₆, [Ir(nbd)₂]OTf, [Ir(nbd)₂]ClO₄, [Ir(nbd)₂]BF₄, [Ir(nbd)₂]PF₆, [Ir(nbd)₂]OTf, [Ir(nbd)₂]ClO₄, [Ir(nbd)₂]BF₄, [Ir(nbd)₂]PF₆ and [Ir(nbd)₂]OTf.

The amount of the metal compound used may, based on the metal content, be, for example, 25 to 200 mol % in relation to the compound of the formula (I) used; preference is given to 80 to 140 mol %, very particular preference to 90 to 120 mol % and even greater preference to 95 to 105 mol %.

Very particularly preferred transition metal complexes of compounds of the formula (I) are those which obey the formula (Xa), (Xb) or (Xc)
[M⁵(I)]An (Xa)
[M⁵(I)(CO)Hal]An (Xb)
[Ir(I)(diolefin)]An (Xc)
wherein, in each case,
M⁵ is rhodium or iridium
(I) is a compound of the formula (I)
diolefin is a diene, for example, 1,5-cyclooctadiene or norbornadiene and
An without regard for a possible coordination to the metal atom, is an anion, for example chloride, bromide, iodide, methanesulfonate, trifluoromethanesulfonate, tetrafluoroborate, hexafluorophosphate, perchlorate, hexafluoroantimonate, tetra(bis-3,5-trifluoromethylphenyl)borate or tetraphenylborate and
Hal is chloride, bromide or iodide.

The catalysts which comprise transition metal complexes generated in situ or isolated transition metal complexes are suitable especially for use in homogeneous catalysis.

Preference is given to using the inventive catalysts for hydrogenations, more preferably for asymmetric hydrogenations, when the compounds are chiral under the prerequisites stated at the outset.

Preferred hydrogenations are, for example, hydrogenations of prochiral C=C bonds, for example prochiral enamines, olefins, enol ethers, C=O bonds, for example prochiral ketones, and C=N bonds, for example prochiral imines. Particularly preferred asymmetric hydrogenations are hydrogenations of C=O bonds, for example prochiral ketones.

In a preferred embodiment, the hydrogenation is carried out in the presence of a hydrogen donor molecule and optionally of a base.

Hydrogen donor molecules are, for example, molecular hydrogen, formic acid, ethanol or isopropanol; bases are, for example, alkoxides or tertiary amines. Particularly preferred mixtures of hydrogen donor molecule and base are mixtures of formic acid and triethylamine, in particular the azeotropic mixture thereof, and mixtures of potassium isopropoxide and isopropanol.

The amount of the metal compound used or of the transition metal complex used may, based on the particular metal content, be, for example, 0.001 to 20 mol %, based on the substrate used, preferably 0.001 to 2 mol %, most preferably 0.001 to 1 mol %.

In a preferred embodiment, asymmetric hydrogenations may be carried out, for example, in such a way that the catalyst is generated in situ from a metal compound and a compound of the formula (I), optionally in a suitable organic solvent, the substrate is added and the reaction mixture, at reaction temperature, is either placed under hydrogen pressure or admixed with a mixture of another hydrogen donor molecule and a base.

The inventive catalysts are suitable in particular in a process for preparing active ingredients of medicaments and agrochemicals, or intermediates of these two classes.

The advantage of the present invention lies in the possibility of preparing a whole class of high-performance catalysts using readily obtainable compounds which can be handled without risk.

### EXAMPLES

### Example 1

Synthesis of (S,S)-1,2-bis(5H-dibenzo[a,d]cyclohepten-5-yl)-1,2-diphenylethanediamine (S,S-DPENtrop₂)

667 mg of 5H-dibenzo[a,d]cyclohepten-5-yl chloride (2.95 mmol, 2 eq.) were added at room temperature to 313 mg of (S,S)-diphenylethanediamine (1.47 mmol) in 20 ml of CH₂Cl₂. After 10 min, a white precipitate formed. The suspension was stirred for a further 2 h and concentrated, and the residue was extracted with 10% by weight aqueous potassium carbonate solution and CH₂Cl₂. The organic phase was removed and the aqueous phase was extracted twice more with CH₂Cl₂. The collected organic phases were dried over sodium sulfate and concentrated. Chromatography on silica gel with hexane/diethyl ether (3:2 by volume) and subsequently diethyl ether as eluents gave rise to 846 mg of DPENtrop₂ (1.43 mmol, 97%) as a colourless foam.

In CDCl₃, the compound is present in a symmetrical (approx. 68%) and an asymmetrical (approx. 32%) conformation.

Symmetrical form:¹H NMR (300 MHz, CDCl₃): δ=2.48 (d, J=7.8 Hz, 2H, NH), 3.09 (s, 2H, CHN_{Trop}), 4.49 (d, J=7.8 Hz, 2H, CH(Ph)(NHTrop)), 6.36 (d, J=11.8 Hz, 2H, CH_{olefin}), 6.72 (d, J=11.8 Hz, 2H, CH_{olefin}), 6.83-7.47 (m, 26H, CH_{aryl}). ¹³C NMR (75 MHz, CDCl₃):δ=65.4 (2C, CHN_{Trop}), 66.4 (2C, CH(Ph)(NH_{Trop})), 126.7 (2C, CH_{aryl}), 126.8 (2C, CH_{aryl}), 126.9 (2C, CH_{aryl),} 127.6 (2C, CH_{aryl}), 128.0 (4C, CH_{aryl}), 128.2 (4C, CH_{aryl}), 128.6 (2C, CH_{aryl}), 129.3 (2C, CH_{aryl}), 129.8 (2C, CH_{aryl}), 129.9 (2C, CH_{aryl}), 130.0 (2C, CH_{aryl}), 130.2 (2C, CH_{olefin}), 130.3 (2C, CH_{olefin}), 133.6 (2C, C_{quart}), 133.8 (2C, C_{quart}), 139.3 (2C, C_{quart}), 140.1 (2C, C_{quart}), 141.0 (2C, C_{quart}). IR: v=3317 m, (NH), 3020 m, 1599 w, 1489 m, 1451 s, 1436 s, 1071 m, 797 s, 760 s, 697 s. MS (70 eV, m/z, %): 538 (44), 476 (50), 296 (27), 207 (18), 191 (100).

Selected data of asymmetrical form:¹H NMR (300 MHz, CDCl₃): δ=2.78 (br, 1H, NH), 3.13 (br, 1H, NH), 3.37 (d, J=7.0 Hz, 1H, CH(Ph)(NHTrop)), 3.74 (s, 1H, CHN_{Trop}), 3.74 (d, J=7.0 Hz, 1H, CH(Ph)(NHTrop)), 4.74 (d, J=5.1 Hz, 1H, CHN_{Trop}), 6.82-7.38 (m, 25H, CH_{aryl} ) 7.7 (d, J=7.8 Hz, 1H, CH_{aryl}).

### Example 2

Synthesis of (R,R)-1,2-bis(5H-dibenzo[a,d]cyclohepten-5-yl)-1,2-diaminocyclohexane

(R,R-DACHtrop₂)

20 ml of saturated aqueous potassium carbonate solution were added in a dropping funnel to 264 mg of the tartaric acid salt of (R,R)-diaminocyclohexane (1.00 mmol) in 15 ml of CH₂Cl₂. The mixture was shaken vigorously and the organic phase was removed. The aqueous phase was extracted twice more with 5 ml of CH₂Cl₂, and the collected organic phases were dried over sodium sulfate and filtered. 3 ml of triethylamine and then 454 mg of 5H-dibenzo[a,d]cyclohepten-5-yl chloride (2.00 mmol) were added to this solution. The solution was stirred at room temperature for 15 min and then heated to boiling for 5 min. As this was done, a white solid precipitated out. Removal of the solvent under reduced pressure gave rise to a colourless solid which was taken up in 50 ml of CH₂Cl₂ and 20 ml of 10% by weight aqueous potassium carbonate solution. The organic phase was removed and the aqueous phase was extracted twice more with 20 ml of CH₂Cl₂. The collected organic phases were dried over sodium sulfate, filtered and concentrated under reduced pressure. Chromatography on silica gel with hexane/diethyl ether (1:1 by volume) and subsequently diethyl ether as eluents gave rise to 444 mg of DACHtrop₂ (0.90 mmol, 90%) as a colourless solid.

Symmetrical form: ¹H NMR (300 MHz, CDCl₃): δ=0.54-1.21 (m, 4H, CH_{2cyc}), 1.37-1.72 (m, 4H, CH_{2cyc}), 2.0 (m, 2H, CH_{cyc}) 2.3 (br, 2H, NH), 4.8 (s, br, 2H, CHN_{Trop}), 6.6 (d, J=11.7 Hz, 2H, CH_{olefin}), 6.8 (d, J=11.7 Hz, 2H, CH_{olefin}), 7.4 (m, 16H, CH_{aryl}).

Asymmetrical form: ¹H NMR (300 MHz, CDCl₃): δ=0.63-2.34 (m, 10H, CH_{2cyc}und CH_{cyc}) 1.95 (br, 1H, NH), 2.85 (br, 1H, NH), 4.21 (d, J=3.7 Hz, 1H, CHN_{Trop}), 5.12 (br, 1H, CHN_{Trop}), 7.11-7.66 (m, 20H, CH_{Trop}und CH_{olefin}). ¹³C NMR (75 MHz, CDCl₃): δ=24.9-32.1 (8C, CH_{2cyc}), 56.2 (CHN_{Trop, asym}), 59.5 (CHN_{cyc, asym}), 59.8 (CHN _{cyc, asym}) 60.3 (2C, CHN_{cyc, sym}) 67.1 (CHN_{Trop,asym}) 67.7 (2C, CHN_{Trop, sym}), 122.7-134.3 (40C, CH_{aryl}und CH_{olefin}), 131.5-139.0 (16C, C_{quart}).

IR: v=3302 m, (NH), 3014 m, 2919 m, 1486 m, 1436 s, 1101 m, 798 s, 764 s, 729 s. MS (70 eV, m/z, %): 494 (1), 303 (61), 191 (100), 96 (20).

### Example 3

Synthesis of [Ir(Cl)(CO)(S,S-DPENtrop₂)]

A suspension of 29.6 mg of S,S-DPENtrop₂ (0.05 mmol) from Example 1 and 15.5 mg of [Ir(CO)₃(Cl)] (0.05 mmol) in CD₃CN (0.45 ml) were heated to 60° C. for 3 h. In the course of cooling, 31 mg of [Ir(Cl)(CO)(DPENtrop₂)] (0.036 mmol, 72%) crystallized out.

Alternative synthesis: 5 ml of acetonitrile were added under an atmosphere of carbon monoxide to 119 mg of DPENtrop₂ (0.20 mmol) and 67 mg of [Ir(COD)(Cl)]₂ (0.10 mmol). When this was done, a yellow-green solution formed which, after stirring at RT for 1 h, was filtered and concentrated under reduced pressure. The residue was recrystallized from toluene and gave rise to 127 mg of [Ir(Cl)(CO)(DPENTrop₂)] (0.15 mmol, 75%).

¹H NMR (300.1 MHz, CD₂Cl₂): δ=3.18 (dd, ³J_{HH}=11.3 Hz, ³J_{HH}=11.0 Hz, 1H, CH(NH)(Ph)), 3.35 (d, ³J_{HH}=8.3 Hz, 1H, CH_{olefin}), 3.80(d, ³J_{HH}=8.3 Hz, 1H, CH,_{olefin}), 4.29 (dd, ³J_{HH}=11.4 Hz, ³J_{HH}=11.3 Hz, 1H, CH(NH)(Ph)), 4.39 (d, ³J_{HH}=2.0 Hz, 1H, CHNₜᵣₒₚ), 5.50 (dd, J=11.2 Hz, J=2.0 Hz, 1H, NH), 5.87 (dd, J=11.0 Hz, J=10.6 Hz, 1H, NH), 5.90 (s, br, 2H, CHₐᵣ), 6.44 (d, J=7.1 Hz, 1H, CHₐᵣ), 6.46 (d, J=11.7 Hz, 1H, CH_{olefin}), 6.67 (d, J=10.6 Hz, 1H, CHNₜᵣₒₚ), 6.65-6.71 (m, 2H, CHₐᵣ), 6.79-6.85 (m, 3H, CHₐᵣ), 7.05 (ddd, J=7.6 Hz, J=7.6 Hz, J=1.2 Hz, CHₐᵣ), 7.11-7.51 (m, 15H, CHₐᵣ), 7.16 (d, J=11.7 Hz, 1H, CH_{olefin}), 7.61 (d, J=7.6 Hz, 1H, CHₐᵣ), 7.95 (d, J=7.6 Hz, 1H, CHₐᵣ). —₁₃ C NMR (75.5 MHz, CD₂Cl₂): δ=26.4 (CHₜᵣₒₚ), 28.0 (CHₜᵣₒₚ), 64.1 (CHNₜᵣₒₚ), 70.4 (CHNₜᵣₒₚ), 71.2 (CH(Ph)N), 73.5 (CH(Ph)N), 124.9 (CHₐᵣ), 125.2 (CHₐᵣ), 126.3 (CHₐᵣ), 127.2 (CHₐᵣ), 127.7 (2C, CHₐᵣ), 127.9 (CHₐᵣ), 128.2 (CHₐᵣ), 128.3 (CHₐᵣ), 128.5 (CHₐᵣ), 128.6 (CHₐᵣ), 128.9 (3C, CHₐᵣ), 128.9 (CH_{olefin}), 129.0 (CHₐᵣ), 129.0 (CHₐᵣ), 129.1 (CHₐᵣ), 129.1 (CHₐᵣ), 129.2 (CHₐᵣ), 129.4 (CHₐᵣ), 129.7 (CHₐᵣ), 130.9 (CH_{olefin}), 131.5 (CHₐᵣ), 133.2 (2 C_{quart}), 133.9 (C_{quart}), 135.2 (C_{quart}), 136.2 (C_{quart}), 136.5 (C_{quart}), 137.9 (C_{quart}), 138.9 (C_{quart}), 139.1 (C_{quart}), 141.2 (CO); (rotation of a phenyl substituent about the Cᵢₚₛₒ-CH(Ph)N bond leads to markedly broadened resonances for the ortho and meta carbons). IR: v=3271 m, 3171 w, 3020 w, 1975 vs (CO), 1489 m, 1454 m, 1422 w, 1260 w, 1084 w, 987 m, 936 m, 797 m, 732 s.

### Example 4

Catalytic transfer hydrogenation with [Ir(Cl)(CO)(S,S-DPENtrop₂)]

120 mg of acetophenone (1 mmol) and 11 mg of potassium tert-butoxide (0.1 mmol) were added to a solution of 0.01 mmol of [Ir(Cl)(CO)(DPENtrop₂)]from Example 3 in 10 ml of 2-propanol, and the mixture was heated to 80° C. for 1 h. Gas chromatography of the reaction solution (Machery-Nagel Lipodex-E chiral column) showed full conversion of acetophenone to (R)-1-phenylethanol. The product is obtained with an enantiomeric excess of 82% ee.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

1. Compounds of the formula (1) 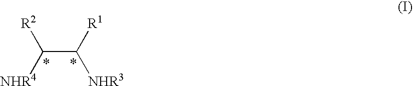
wherein
* marks a stereogenic carbon atom which may be (S)- or (R)-configured
R¹ and R² are each independently selected from the group of C₁-C₁₂-alkyl, C₁-C₁₂-alkoxy, C₁-C₁₂-haloalkoxy, C₁-C₁₂-haloalkyl, C₄-C₁₄-aryl, C₅-C₁₅-arylalkyl, or together are C₃-C₁₂-alkylene or C₃-C₁₂-alkenylene,
R³ and R⁴ are each independently radicals of the formula (II) 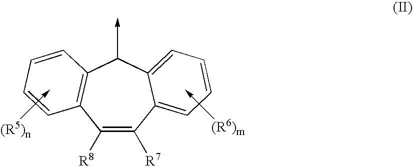
where
the arrows each indicate the bond of the overall radical to the nitrogen atom or, when they point into the middle of an aromatic system, a bond of the particular radicals to the aromatic skeleton in any position,
R⁵ and R⁶ are each independently selected from the group of fluorine, chlorine, bromine, iodine, nitro, free or protected formyl, C₁-C₁₂-alkyl, C₁-C₁₂-alkoxy, C₁-C₁₂-haloalkoxy, C₁-C₁₂-haloalkyl, C₄-C₁₄-aryl, C₅-C₁₅-arylalkyl or radicals of the formula (IV)
L-Q-T-W (IV)
wherein, each independently,
L is absent or is C₁-C₈-alkylene or C₂-C₈-alkenylene and
Q is absent or is oxygen, sulfur or NR⁹,
T is a carbonyl group and
W is R⁹, OR⁹, NHR⁹ or N(R¹⁰)₂,
where N(R¹⁰)₂ as a whole may also be a 5- or 6-membered cyclic amino radical, or radicals of the formulae (Va-g)
L-W (Va)
L-SO₂-W (Vb)
L-NR¹²SO₂R¹² (Vc)
L-SO₃Z (Vd)
L-PO₃Z₂ (Ve)
L-COZ (Vf)
L-CN (Vg)
wherein L, Q, W and R¹⁰ are each as defined under formula (IV) and Z is hydrogen or M and
R⁷ and R⁸ are each independently hydrogen, cyano, fluorine, chlorine, bromine, iodine, C₁-C₁₈-alkyl, C₄-C₂₄-aryl, C₅-C₂₅-arylalkyl, CO₂M where M may be an alkali metal ion or an optionally organic ammonium ion, CONH₂, SO₂N(R⁹)₂ where R⁹ is hydrogen, C₁-C₁₂-alkyl, C₄-C₁₄-aryl or C₅-C₁₅-arylalkyl, SO₃M or are radicals of the formula (III),
T-Het-R¹⁰ (III)
wherein
T is absent or is carbonyl,
Het is oxygen or NR⁹,
R¹⁰ is C₁-C₁₈-alkyl, C₄-C₂₄-aryl or C₅-C₂₅-arylalkyl or N(R¹⁰)₂ as a
whole is a 5- or 6-membered cyclic amino radical and
n and m are each independently 0, 1, 2 or 3.

2. Process for preparing compounds according to claim 1, wherein compounds of the formula (VI) 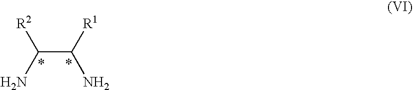
wherein R¹ and R² are each as defined in claim 1 are reacted with compounds of the formula (VII) 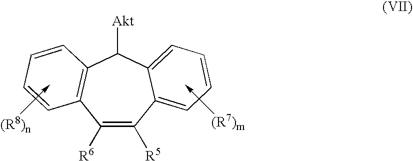
wherein R⁵, R⁶, R⁷, R⁸, n and m are each as defined in claim 1 and wherein Akt is Chlorine, Bromine, Iodine, Trifluoracetyl or a sulfonyloxy radical the ammonium salts of the formulae (VIIIa) and/or (VIIIb) and/or (VIIIc) 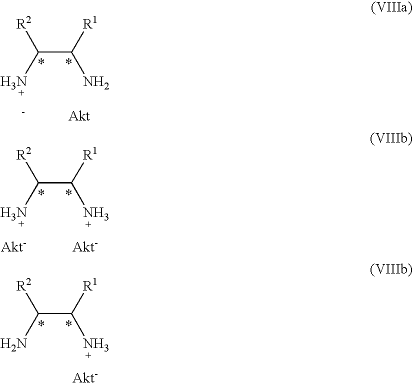
which are formed are converted to compounds of the formula (I), according to claim 1 in the presence of base, either in situ or in a subsequent reaction step.

3. Compounds of the formulae (VIIIa), (VIIIb) and (VIIIc) according to claim 2.

4. Transition metal complexes of compounds of the formula (1) according to claim 1.

5. Transition metal complexes according to claim 4, wherein they are transition metal complexes of ruthenium, osmium, cobalt, rhodium, iridium, nickel, palladium, platinum and copper.

6. Transition metal complexes according to claim 4 or 5, wherein they have been obtained from compounds of the formula (I) according to claim 1 and a metal compound, or transition metal complexes which have been obtained from the compounds of the formula (I) and a metal compound in the reaction medium.

7. Transition metal complexes according to claim 4, 5 or 6 , wherein they obey the formula (Xa), (Xb) or (Xc)
[M⁵(I)]An (Xa)
[M⁵(I)(CO)Hal]An (Xb)
[Ir(I)[diolefin)]An (Xc)
wherein, in each case,
M⁵ is rhodium or iridium
(I) is a compound of the formula (I)
diolefin is a diene, for example, 1,5-cyclooctadiene or norbornadiene and
An without regard for a possible coordination to the metal atom, is an anion and
Hal is chloride, bromide or iodide.

8. Catalysts comprising transition metal complexes according to claim 4, 5, 6 or 7.

9. Use of catalysts according to claim 8 for hydrogenations.
